(19) United States
(12) Patent Application Publication
(10) Pub. No.: US 2024/0361000 A1
(43) Pub. Date: Oct. 31, 2024

(54) HEATING COOKER

(71) Applicant: SAMSUNG ELECTRONICS CO., LTD., Suwon-si (KR)

(72) Inventors: Kazuyuki ONO, Suwon-si (KR); Nobuhiko SHINOHARA, Suwon-si (KR)

(21) Appl. No.: 18/761,649

(22) Filed: Jul. 2, 2024

Related U.S. Application Data
(63) Continuation of application No. PCT/KR2022/019567, filed on Dec. 5, 2022.

(30) Foreign Application Priority Data
Jan. 17, 2022 (JP) 2022-005291

(51) Int. Cl. F24C 7/08; F24C 7/06; F24C 15/00; F24C 15/32

(52) U.S. Cl. CPC F24C 7/08; F24C 7/06; F24C 15/006; F24C 15/325

(57) ABSTRACT

A heating cooker disclosed herein includes a main body including a heating chamber in which food ingredients are placed, and a blowing path through which cooling wind flows. A heating device heats the inside of the heating chamber. A control device is arranged in the blowing path. The control device controls the heating device. A cooling fan generates cooling wind. A sound detector detects sounds including a cooking sound coming from food ingredients being heated in the heating chamber. The sound detector is arranged outside the heating chamber and near the blowing path.

### CROSS-REFERENCE TO RELATED APPLICATIONS

This application is a continuation application of International Application No. PCT/KR2022/019567 designating the United States, filed on Dec. 5, 2022, in the Korean Intellectual Property Receiving Office and claiming priority to Japanese Patent Application No. 2022-005291, filed on Jan. 17, 2022, the disclosures of which are incorporated by reference herein in their entireties.

### TECHNICAL FIELD

The present disclosure relates to a heating cooker for cooking food ingredients by applying heat.

### BACKGROUND ART

A heating cooker may output a cooking sound of food ingredients. For example, Japanese Unexamined Patent No. 2020-159635 discloses a microwave oven including a microphone and a speaker. The microphone is installed inside a heating chamber to collect sound data including a sound coming from food being heated inside the heating chamber. The speaker outputs the sound data input to the microphone.

### DISCLOSURE

### Technical Solution

A heating cooker according to an aspect of the present disclosure includes a main body including a heating chamber in which food ingredients are placed, and a blowing path through which cooling wind flows. A heating device heats the inside of the heating chamber. A control device is arranged in the blowing path. The control device controls the heating device. A cooling fan generates cooling wind. A sound detector detects sounds including a cooking sound coming from food ingredients being heated in the heating chamber. The sound detector is arranged outside the heating chamber and near the blowing path.

### DESCRIPTION OF DRAWINGS

FIG. 1 is a schematic overall configuration diagram of a heating cooking system according to an embodiment of the present disclosure.

FIG. 2 is a perspective view of a heating cooker according to an embodiment of the present disclosure, as seen from an upper right side.

FIG. 3 is a perspective view of a heating cooker according to an embodiment of the present disclosure, as seen from a lower right side.

FIG. 4 is a front view of the inside of a heating chamber with a door opened in a heating cooker, according to an embodiment of the present disclosure.

FIG. 5 is a cross-sectional view taken along line V-V of FIG. 4.

FIG. 6 is a cross-sectional view taken along line VI-VI of FIG. 4.

FIG. 7 is a cross-sectional view taken along line VII-VII of FIG. 4.

FIG. 8 is a cross-sectional view of main parts of a heating cooker according to an embodiment of the present disclosure.

FIG. 9 is a cross-sectional view illustrating main parts of a heating cooker in operation, according to an embodiment of the present disclosure.

FIG. 10 is a cross-sectional view illustrating main parts in a state in which a door of a heating cooker is opened, according to an embodiment of the present disclosure.

FIG. 11 shows a graph of frequency characteristics of a cooking sound of food ingredients and a noise, a graph of frequency characteristics of a noise removal filter, and a relationship diagram showing an example of a relationship between the frequency characteristics.

FIG. 12 is a block diagram illustrating a control device and its main related devices, according to an embodiment of the present disclosure.

FIG. 13 is a cross-sectional view illustrating main parts of a heating cooker corresponding to FIG. 9, according to an embodiment of the present disclosure.

FIG. 14 is a cross-sectional view illustrating main parts in a state in which a door of the heating cooker illustrated in FIG. 13 is opened, according to an embodiment of the present disclosure.

FIG. 15 is a cross-sectional view illustrating main parts of a heating cooker according to an embodiment of the present disclosure.

FIG. 16 is a cross-sectional view illustrating main parts in a state in which a door of the heating cooker illustrated in FIG. 15 is opened, according to an embodiment of the present disclosure.

FIG. 17 is a cross-sectional view illustrating main parts of a heating cooker corresponding to the cross-sectional view taken along line V-V in FIG. 4, according to an embodiment of the present disclosure.

FIG. 18 is a flow diagram illustrating a method of detecting a cooking sound according to an embodiment of the present disclosure.

### MODE FOR INVENTION

Although the terms used herein are selected from among common terms that are currently widely used in consideration of their functions in the present disclosure, the terms may be different according to an intention of one of ordinary skill in the art, a precedent, or the advent of new technology. Also, in particular cases, the terms are discretionally selected by the applicant of the present disclosure, in which case, the meaning of those terms will be described in detail in the corresponding part of the detailed description. Therefore, the terms used herein are not merely designations of the terms, but the terms are defined based on the meaning of the terms and content throughout the present disclosure. Throughout the present specification, when a part “includes” a component, it means that the part may additionally include other components rather than excluding other components as long as there is no particular opposing recitation.

Hereinafter, embodiments of a heating cooker according to the present disclosure will be described in detail with reference to the accompanying drawings such that those of skill in the art may easily implement the present disclosure. The present disclosure may be embodied in many different forms and should not be construed as being limited to an embodiment set forth herein. In order to clearly describe the disclosure, portions that are not relevant to the description of the present disclosure are omitted, and similar reference numerals are assigned to similar elements throughout the present specification.

In the following description, the upper side of a heating cooker in the vertical direction is referred to as “top” and the lower side is referred to as “bottom”, a door side of a heating chamber is referred to as “front”, the side opposite to the door side is referred to as “rear”, and the left side when viewed from the front where the door is installed is referred to as “left”, and the right side is referred to as “right”. In addition, the drawings are for conceptually describing the present disclosure. Thus, in the drawings, dimensions, ratios, or numbers may be exaggerated or simplified to facilitate understanding of the present disclosure.

In a heating cooker such as an oven, the inside of a heating chamber becomes extremely hot during heating and cooking of food ingredients. When a microphone is installed inside the heating chamber, the microphone may be exposed to heat and thus may not operate normally. In addition, soot may be formed in the heating chamber of the heating cooker as food ingredients are heated and cooked. If soot formed inside the heating chamber adheres to the microphone, it may prevent a sound from being input into the microphone, deteriorating the quality of sounds collected by the microphone. The present disclosure provides a heating cooker for allowing a sound detector to operate normally and suppressing degradation of the quality of sounds collected by the sound detector.

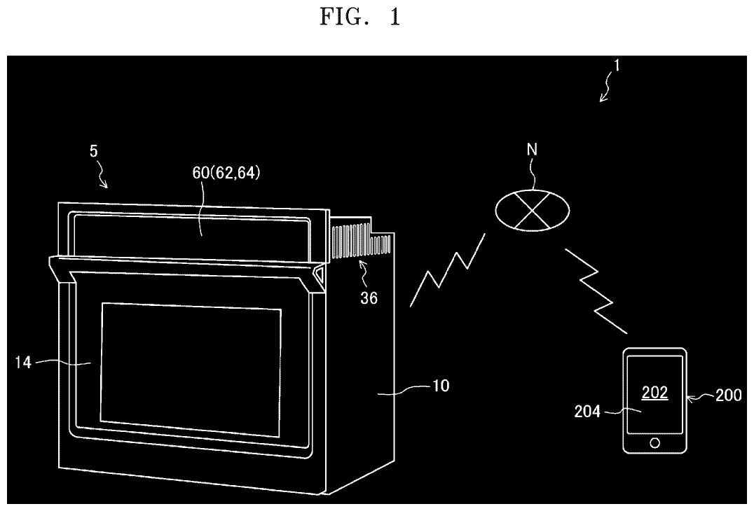

FIG. 1 is a schematic overall configuration diagram of a heating cooking system according to an embodiment of the present disclosure. Referring to FIG. 1, a heating cooking system 1 may include a heating cooker 5 and an information terminal 200. The heating cooker 5 and the information terminal may exchange information and data via a data network N. The data network can include, for example, a wireless data network and/or cloud computing network. The heating cooking system 1 may be a system for providing a user using the heating cooker 5 with an image of food ingredients F being heated and cooked, and a cooking sound coming from the food ingredients F. The provision of the image and the cooking sound of the food ingredients F by the heating cooking system 1 supports the user using the heating cooker 5 to experience a sense of presence during cooking by imaging a cooking state of the food ingredients F being heated and cooked.

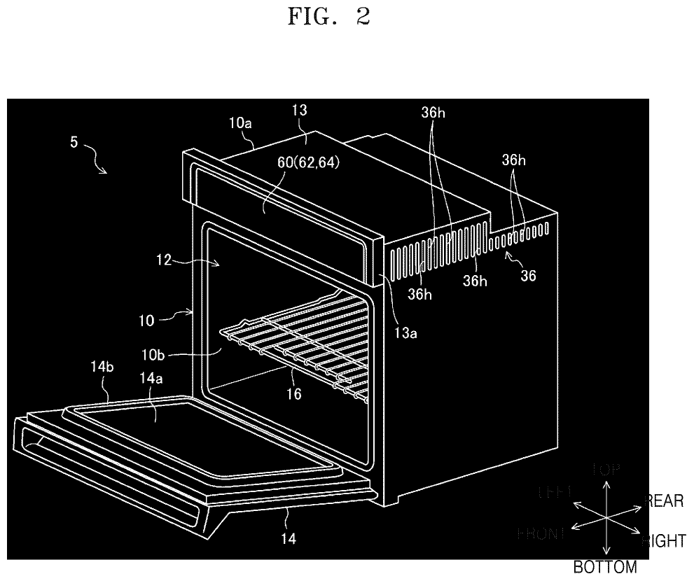

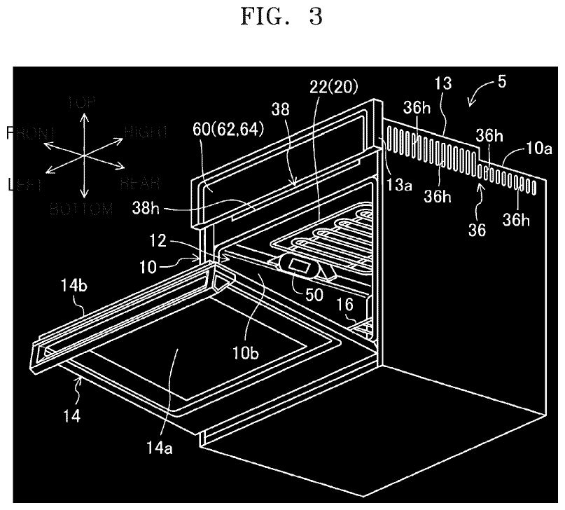

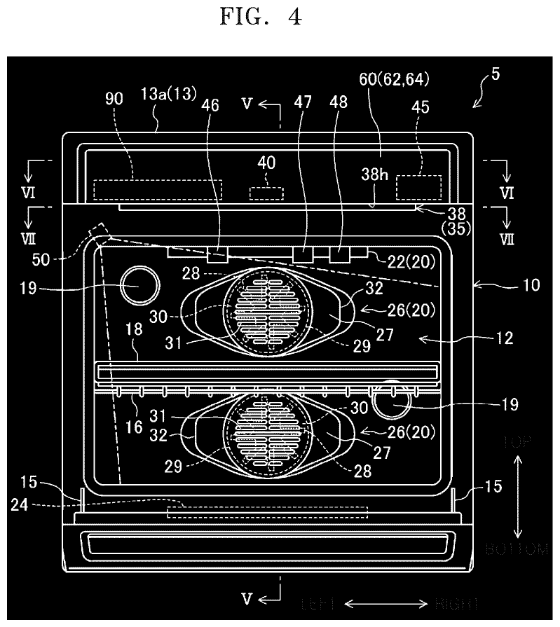

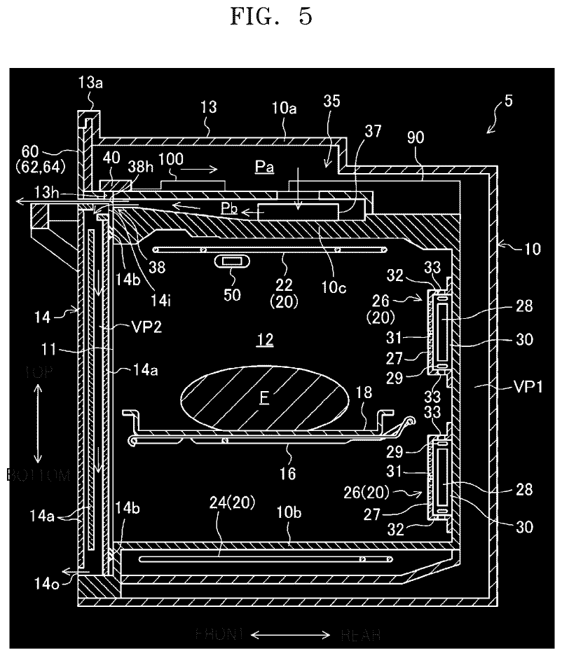

The heating cooker 5 may be a so-called convection oven. The heating cooker 5 may have a function of automatically heating and cooking the food ingredients F. FIG. 2 is a perspective view of the heating cooker 5 according to an embodiment of the present disclosure, as seen from an upper right side. FIG. 3 is a perspective view of the heating cooker 5 according to an embodiment of the present disclosure, as seen from a lower right side. FIG. 4 is a front view of the inside of a heating chamber 12 with a door 14 opened in the heating cooker 5, according to an embodiment of the present disclosure. FIG. 5 is a cross-sectional view taken along line V-V of FIG. 4. Referring to FIGS. 2 to 5, the heating cooker 5 may include a main body 10, a heating device 20, a cooling mechanism 35, a sound detector 40, and a control device 90. The heating cooker 5 may further include a sound outputter 45, a food ingredient temperature detector 46, a three-dimensional measuring device 47, a chamber temperature detector 48, a photographing device 50, a display unit 62, a manipulation unit 64, and a memory device 70.

The main body 10 may be in the shape of a rectangular parallelepiped box. The main body 10 includes the heating chamber 12 and a blowing path through which cooling wind flows. The heating chamber 12 may be formed in an internal space of the main body 10. The food ingredients F may be placed in the heating chamber 12. Examples of the food ingredients F may include meat, fish, shellfish, vegetables, and those being cooked. An opening 11 is formed on a front surface of the main body 10 (see FIG. 5). The food ingredients F may be put in and out of the heating chamber 12 through the opening 11.

For example, the main body 10 may include an outer housing 10a and an inner housing 10b. The outer housing 10a forms an exterior portion of the main body 10. The outer housing 10a may be formed of a metal plate. The inner housing 10b forms an inner wall of the main body 10. The inner housing 10b may be formed of a combination of a metal plate and a thermal insulation material.

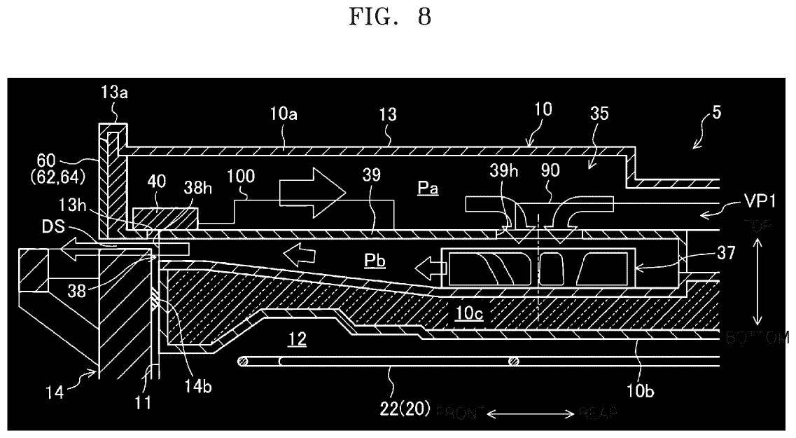

The main body 10 may include a case portion 13. The case portion 13 is formed on an upper part of the main body 10 by the outer housing 10a and the inner housing 10b. The control device 90, the sound detector 40, and the like may be accommodated in the case portion 13. The case portion 13 has a protruding portion 13a protruding in the direction in which the opening 11 of the main body 10 is formed. A sound collection hole 13h (see FIG. 5) is formed on a lower surface of the protruding portion 13a. The sound collection hole 13h is open outside the heating chamber 12 toward the blowing path (a discharge space DS (see FIG. 8)).

A ventilation flow path VP1 is formed between the outer housing 10a including the case portion 13, and the inner housing 10b. The ventilation flow path VP1 is a flow path for allowing air coming from the outside to flow. The ventilation flow path VP1 is installed over approximately the entirety of the main body 10, that is, an upper part, a lower part, left and right parts, and a rear part. The door 14 is installed on a front surface (an opening surface) of the main body 10. The door 14 is connected to the main body 10 to be rotatable by a hinge (not shown) provided below the opening 11 of the main body 10.

The door 14 opens and closes the opening 11 of the heating chamber 12 by rotating, for example, in the vertical direction about a rotation axis extending in the left-right direction of the hinge. The door 14 may include a plurality of heat-resistant plates 14a and a packing member 14b. The packing member 14b may be installed in the form of a frame in a portion of a rear surface of the door 14, that is, a surface facing the inside of the heating chamber 12, the portion facing an edge of the opening 11 of the main body 10. The packing member 14b may be formed of synthetic rubber. The cross-sectional shape of the packing member 14b may be, for example, a trapezoidal shape. When the door 14 is closed, the packing member 14b is in close contact with the edge of the opening 11 of the main body 10, to seal the space between the door 14 and the main body 10.

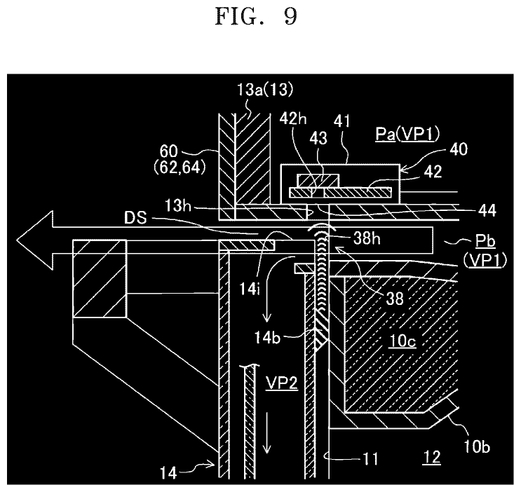

A ventilation flow path VP2 may be provided inside the door 14 (See FIG. 9). The heat-resistant plates 14a may be formed of heat-resistant glass or the like. The plurality of heat-resistant plates 14a may be arranged at intervals to face each other in the thickness direction of the door 14, that is, in the front-rear direction. The ventilation flow path VP2 may be formed between the heat-resistant plates 14a adjacent to each other. An inlet 14i may be formed at an upper end of the door 14. The inlet 14i may be in communication with the ventilation flow path VP2, and may be open toward the top and/or rear (toward the heating chamber 12) to allow cooling wind to be introduced from the blowing path, for example, the discharge path DS, into the ventilation flow path VP2. An outlet 14o may be provided at a lower end of the door 14. The outlet 14o may be in communication with the ventilation flow path VP2 and may be open toward the front.

Referring to FIGS. 2-5, a shelf 16 is installed in the heating chamber 12. The shelf 16 may include a rectangular frame member formed of wire, and a plurality of rod-shaped members arranged in the left-right direction while crossing the inside of the frame member in the front-rear direction. Both ends of the shelf 16 in the left-right direction are supported by a sidewall of the main body 10, that is, a side surface that partitions the heating chamber 12. A tray 18 is placed on the shelf 16. The tray 18 may be formed of a metal plate. The food ingredients F are placed on the tray 18.

An inner lamp 19 may be installed on a rear wall of the main body 10, that is, on a rear surface that partitions the heating chamber 12. For example, two inner lamps 19 may be installed in two upper and lower areas into which the heating chamber 12 is partitioned, respectively. One inner lamp 19 may be arranged on an upper left side of the heating chamber 12. The other inner lamp 19 may be arranged on a lower right side of the heating chamber 12. The inner lamp 19 illuminates the inside of the heating chamber 12 such that the state or the like of the food ingredients F being heated and cooked may be easily checked. The inner lamp 19 may include, for example, an incandescent bulb, a fluorescent bulb, or a light-emitting diode (LED) bulb.

The heating device 20 heats the inside of the heating chamber 12. The heating device 20 may include a plurality of heaters. For example, the plurality of heaters may include an upper heater 22, a lower heater 24, and a convection heater 26. The outputs of the upper heater 22, the lower heater 24, and the convection heater 26 may be individually and independently adjusted by the control device 90, which will be described below.

The upper heater 22 may be installed on an upper wall of the main body 10. For example, the upper heater 22 may be arranged along the upper surface of the inner housing 10b. The lower heater 24 may be installed on a lower wall of the main body 10. For example, the lower heater 24 may be buried below the lower surface of the inner housing 10b. The upper heater 22 and the lower heater 24 may each include, for example, a heating wire that generates heat by supply of an electric current. The upper heater 22 and the lower heater 24 may be infrared heaters that emit infrared rays, or may be a combination of a heating wire and an infrared heater.

The convection heater 26 may be installed on the rear wall of the main body 10, that is, on the rear surface that partitions the heating chamber 12, in a central portion in the left-right direction. Two convection heaters 26 may be installed to be spaced apart from each other in the vertical direction. The convection heater 26 may include a casing 27, a circulation fan 28, and a heating unit 29. The casing 27 may have a roughly oval shallow dish shape when viewed from the front. The casing 27 may be attached to the rear surface of the main body 10 with an opening facing the rear.

The casing 27 protrudes into the heating chamber 12 to form an accommodation portion 30 between the casing 27 and the rear surface of the main body 10. A suction hole 31 that is open toward the front is formed in a central portion of the casing 27. A vent 33 is formed on a sidewall 32 of the casing 27. The circulation fan 28 is accommodated in the accommodation portion 30 of the casing 27 and arranged behind the suction hole 31. The circulation fan 28 may be, for example, a centrifugal fan.

The heating unit 29 is installed in the accommodation portion 30 of the casing 27 to surround the circulation fan 28. The heating unit 29 may include, for example, a heating wire that generates heat by supply of an electric current. The convection heater 26 rotates the circulation fan 28 to suck in air in the heating chamber 12 from the suction hole 31 into the casing 27 and flow it to the outer circumference of the circulation fan 28, and discharge air heated by the heating unit 29 into the heating chamber 12 through the vent 33. As such, the air in the heating chamber 12 is circulated, and heat is convected inside the heating chamber 12.

The output of the heating device 20 is adjustable. The output of the heating device 20 depends on the number and outputs of heaters in operation among the plurality of heaters, for example, the upper heater 22, the lower heater 24, and the convection heater 26. For example, when the plurality of heaters have the same output, the output of the heating device 20 increases as the number of heaters in operation state among the plurality of heaters increases. In addition, as the output of a heater in operation among the plurality of heaters increases, the output of the heating device 20 increases.

In addition, each of the plurality of heaters included in the heating device 20, for example, the upper heater 22, the lower heater 24, and the convection heater 26, may be switched between a continuous operation state in which the heater operates continuously, and an intermittent operation state in which the heater operates intermittently. The proportion of the operation time for an operation cycle of each of the plurality of heaters may be changed. For example, when the upper heater 22 is switched from the continuous operation state to the intermittent operation state, the output of the upper heater 22 decreases. In addition, when the proportion of the operation time for the operation cycle of the upper heater 22 in the intermittent operation state decreases, the output of the upper heater 22 decreases.

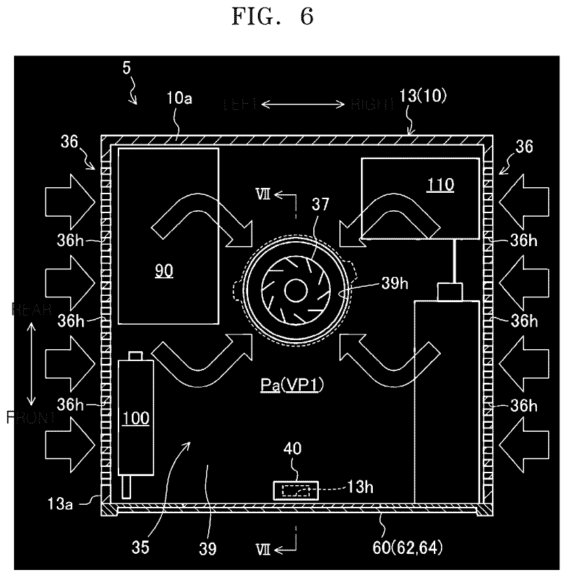

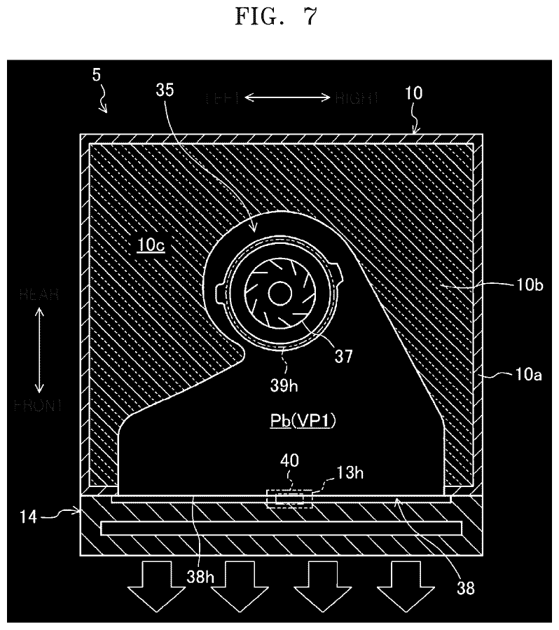

With continued reference to the figures, FIG. 6 is a cross-sectional view taken along line VI-VI of FIG. 4. FIG. 7 is a cross-sectional view taken along line VII-VII of FIG. 4. FIG. 8 is a cross-sectional view of main parts of the heating cooker 5 according to an embodiment of the present disclosure. The cooling mechanism 35 (see FIG. 5) is a mechanism that supplies external air to cool (air-cool) the control device 90 and the like. The cooling mechanism 35 may include a blowing path and a cooling fan 37. The blowing path may include an intake portion 36, a first flow path Pa, a second flow path Pb, and an exhaust portion 38.

As illustrated in FIGS. 2, 3, and 6, the intake portion 36 is a portion that sucks in external air into the case portion 13. The intake unit 36 may include a plurality of intake holes 36h. The plurality of intake holes 36h may be formed on left and right side surfaces of the outer housing 10a forming the case portion 13. The plurality of intake holes 36h may be arranged at intervals from each other in the front-rear direction. The intake hole 36h has, for example, a long hole shape. The intake holes 36h penetrate the outer housing 10a to be in communication with the first flow path Pa.

As illustrated in FIG. 8, the first flow path Pa and the second flow path Pb may be located above the heating chamber 12. The first flow path Pa may be formed in an inner space of the case portion 13. The second flow path Pb may be provided below the case portion 13. The first flow path Pa and the second flow path Pb are spaced apart (separated) from each other in the vertical direction with a partition plate 39 therebetween. The partition plate 39 partitions a portion of the ventilation flow path VP1 into the first flow path Pa and the second flow path Pb in the vertical direction. The first flow path Pa is a flow path located above the partition plate 39. The second flow path Pb is a flow path located below the partition plate 39. A ventilation hole 39h is formed near the center of the partition plate 39 in the front-rear direction. The ventilation hole 39h is a hole for allowing air to flow from the first flow path Pa to the second flow path Pb.

As illustrated in FIG. 6, the first flow path Pa is formed over approximately the entire area of the case portion 13 in the horizontal direction. The control device 90 is located in the first flow path Pa. A locking device 100 for locking the door 14 and a power supply device 110 may also be located in the first flow path Pa. As illustrated in FIG. 7, the second flow path Pb may expand in the left-right direction toward the front from a position corresponding to the ventilation hole 39h. As illustrated in FIG. 8, the periphery of the second flow path Pb and a side of the heating chamber 12 are surrounded by a thermal insulation material 10c installed in the inner housing 10b. The cooling fan 37 is a device configured to generate cooling wind to cool the control device 90 and the like. The cooling fan 37 may be installed at a position corresponding to the ventilation hole 39h in the second flow path Pb. The cooling fan 37 may be, for example, a centrifugal blower.

The exhaust portion 38 is a portion that discharges air from the ventilation flow path VP1. The exhaust portion 38 has an exhaust hole 38h. As illustrated in FIGS. 4 and 5, the exhaust hole 38h may be formed near an upper edge of the opening 11 in the outer housing 10a. The exhaust hole 38h may be located immediately below a control panel 60. For example, the exhaust hole 38h may have a slit shape elongated in the left-right direction. As illustrated in FIG. 8, the exhaust hole 38h penetrates the outer housing 10a to be in communication with the second flow path Pb. The exhaust hole 38h may be open toward the front. In a state in which the door 14 closes the heating chamber 12, the exhaust hole 38h corresponds to a gap G between the inlet 14i of the door 14, the lower surface of the protruding portion 13a of the case portion 13, and the upper surface of the door 14.

When the cooling fan 37 is in operation, cooling wind is generated as indicated by arrows in FIGS. 5 to 8. The cooling wind is an air flow in which external air is sucked into the first flow path Pa through the intake holes 36h, then flows from the first flow path Pa through the ventilation hole 39h of the partition plate 39 to the second flow path Pb, and is then discharged from the exhaust hole 38h. The blowing path through which the cooling wind flows may include the discharge space DS and the ventilation flow path VP2 within the door 14, in addition to the first flow path Pa and the second flow path Pb.

The discharge space DS is a space through which air discharged from the inside of the main body 10 to the outside flows by driving of the cooling fan 37. The discharge space DS is a space that is open toward the front in an upper portion of the opening 11 of the heating chamber 12. The discharge space DS includes a space immediately below the protruding portion 13a of the case portion 13. As illustrated in FIG. 5, part of the cooling wind discharged into the discharge space DS flows into the ventilation flow path VP2 within the door 14 through the inlet 14i of the door 14, flows downward along the ventilation flow path VP2, and then flows out of the outlet 14o. As such, the door 14 is cooled.

The sound detector 40 is a device for detecting sounds, including a cooking sound coming from the food ingredients F being heated in the heating chamber 12. The sound detector 40 includes a microphone. The sound detector 40 is arranged outside the heating chamber 12. The sound detector 40 is accommodated in the main body 10, for example, in the case portion 13.

Referring to FIG. 8, the sound detector 40 may be fixed to the lower surface of the case portion 13, for example, to the partition plate 39, by a bonding method or the like. For example, the sound detector 40 may be arranged outside the heating chamber 12 near the blowing path. For example, the sound detector 40 may be located adjacent to the protruding portion 13a of the case portion 13. The sound detector 40 is arranged above the exhaust hole 38h. The sound detector 40 may be arranged near the opening 11 of the heating chamber 12. The sound detector 40 may be located near the discharge space DS in the blowing path through which the cooling wind flows. As such, the sound detector 40 is installed near the control panel 60 above the opening 11 of the main body 10. The installation position of the sound detector 40 is where a cooking sound of food ingredients coming from the heating chamber 12 may be efficiently detected because the influence of the internal temperature of the heating chamber 12 is small.

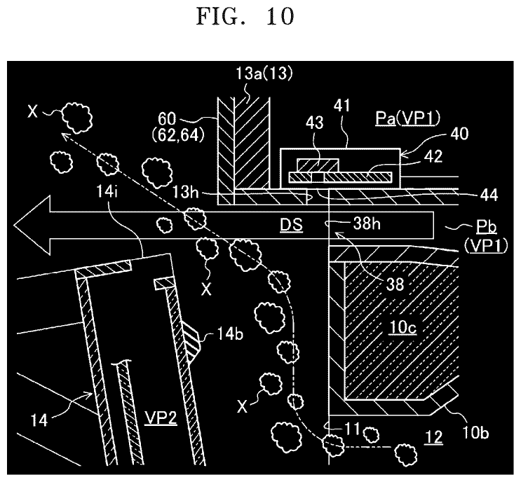

FIG. 9 is a cross-sectional view illustrating main parts of a heating cooker in operation, according to an embodiment of the present disclosure. FIG. 10 is a cross-sectional view illustrating main parts in a state in which the door of the heating cooker illustrated in FIG. 9 is opened, according to an embodiment of the present disclosure. As illustrated in FIG. 9, the sound detector 40 may include an accommodation unit 41, a printed circuit board 42, and a microphone sensor (microphone element) 43. The accommodation unit 41 accommodates the printed circuit board 42 and the microphone sensor 43. The accommodation unit 41 may be formed by a panel, a bezel, or the like. A sound hole 42h is formed in the printed circuit board 42. The sound hole 42h is a hole for collecting sounds that penetrates the printed circuit board 42. The microphone sensor 43 is mounted on the printed circuit board 42 to cover the sound hole 42h. A sound collection portion 44 of the sound detector 40 is a portion that faces the microphone sensor 43 with the sound hole 42h therebetween.

The sound detector 40 may be installed inside the first flow path Pa such that the sound collection portion 44 is aligned with the sound collection hole 13h of the case portion 13, for example, the partition plate 39. The sound collection portion 44 of the sound detector 40 faces the front of the opening 11 of the main body 10 through the sound collection hole 13h. The cooking sound coming from the food ingredients F being heated in the heating chamber 12 is transferred along the door 14, the packing member 14b, and the main body 10, and then leaks out of the heating chamber 12, for example, from the front of the opening 11 of the main body 10. The sound detector 40 detects sounds, including a cooking sound leaking out of the heating chamber 12, through the sound collection hole 13h. A result of detection by the sound detector 40 (collected sound data representing sounds including the cooking sound) is output to the control device 90.

The sound detector 40 is located near the discharge space DS, and thus exposed to and cooled by cooling wind discharged from the ventilation flow path VP1 through the exhaust hole 38h. Accordingly, the reliability of the sound detector 40 may increase. In addition, most of noise components included in a sound detected by the sound detector 40 is the driving sound of the cooling fan 37, and is less affected by ambient noise. The driving sound of the cooling fan 37 is known noise, and thus may be relatively easily removed by software technology using a noise removal filter, which will be described below. In addition, as illustrated in FIG. 10, even when soot (designated as “X”) escapes the heating chamber 12 when the door 14 is opened, the cooling wind discharged from the ventilation flow path VP1 to the discharge space DS serves as an air curtain to withdraw the soot X forward. Accordingly, the soot X may be suppressed from adhering to the sound detector 40.

The sound outputter (also referred to as a sound output device) 45 (see FIG. 4) is a device for outputting a cooking sound based on cooking sound data. The sound outputter 45 may be a speaker. The cooking sound data is sound data that has undergone noise processing to remove noise components including the driving sound of the cooling fan 37, from the collected sound data representing the sounds detected by the sound detector 40. The noise processing can be performed by a hardware controller such as, for example, control device 90. As illustrated in FIG. 4, the sound outputter 45 may be embedded in a front portion of the case portion 13, together with the control panel 60. Cooking sound data is input from the control device 90 to the sound outputter 45.

The food ingredient temperature detector 46 is a device for detecting an internal temperature of the food ingredients F. For example, the food ingredient temperature detector 46 may detect the surface temperature of the food ingredients F in a contactless manner. The food ingredient temperature detector 46 may include, for example, one or more infrared sensors. The food ingredient temperature detector 46 may be installed on the upper surface of the heating chamber 12. The food ingredient temperature detector 46 scans approximately the entire upper surface of the tray 18, and detects the heat distribution of a target area including the food ingredients F. A result of detection by the food ingredient temperature detector 46 (food ingredient temperature data representing the surface temperature of the target area including the food ingredients F) is output to the control device 90.

The three-dimensional measuring device 47 is a device for obtaining three-dimensional data representing the three-dimensional shape of the food ingredients F by measuring the three-dimensional shape of the food ingredients F placed in the heating chamber 12. In addition, the three-dimensional data includes three-dimensional coordinate information representing the three-dimensional shape of the food ingredients F. For example, the three-dimensional measuring device 47 may include a time-of-flight (TOF) camera, a stereo camera, and the like. A result of measurement (three-dimensional data representing the three-dimensional shape of the food ingredients) by the three-dimensional measuring device 47 is output to the control device 90.

The chamber temperature detector 48 is a device for detecting the internal temperature of the heating chamber 12. The chamber temperature detector 48 is installed inside the heating chamber 12. Strictly speaking, the chamber temperature detector 48 detects the temperature of air at the installation position within the heating chamber 12. The chamber temperature detector 48 may include a known temperature sensor, such as a thermistor. A result of detection by the chamber temperature detector 48 (chamber temperature data representing the internal temperature of the heating chamber 12) is output to the control device 90.

The photographing device 50 obtains a captured image of the inside of the heating chamber 12 including the food ingredients F by photographing the inside of the heating chamber 12. For example, the photographing device 50 may include a charge-coupled device (CCD) camera, a complementary metal-oxide-semiconductor (CMOS) camera, and the like. The photographing device 50 is arranged at an upper portion of the left or right side of the main body 10 (an upper left side in the examples illustrated in FIGS. 3 to 5) and at the center in the front-rear direction, such that the food ingredients F in the heating chamber 12 are included in the angle of view. The photographing device 50 in the present example includes one camera. The photographing device 50 may include a plurality of cameras configured to photograph the inside of the heating chamber 12 from different viewpoints. A result of photographing (image data representing a captured image) by the photographing device 50 is output to the control device 90.

The display unit 62 and the manipulation unit 64 may be installed in the form of the control panel 60 on a front portion of the case portion 13 above the opening 11 of the heating chamber 12. The control panel 60 may be implemented as, for example, a display device with a touch panel attached thereto. The display unit 62 may be a screen of a display device constituting the control panel 60. The manipulation unit 64 may be implemented by a touch panel. Of course, the manipulation unit 64 may further include a physical manipulation button, a dial switch, and the like.

The display unit 62 displays information about heat cooking. Examples of information displayed on the display unit 62 include a heat cooking operation mode, the output level of the heating device 20, and a time required for heat cooking. The display unit 62 may also display a captured image. A manipulation regarding heat cooking may be input from the user through the manipulation unit 64. Heat cooking setting information, starting and stopping of heat cooking, and the like may be input through a touch manipulation on the control panel 60 by the user. Information (setting data regarding heating cooking) input through the control panel 60 is output to the control device 90.

The memory device 70 stores various types of information. The memory device 70 may include, for example, a known memory device such as a hard disk drive (HDD) or a solid-state drive (SSD). The memory device 70 may be embedded in the heating cooker 5. The memory device 70 may include an external memory device installed outside the main body 10. The memory device 70 may store a food ingredient image prepared for each type of the food ingredients F. The food ingredient image is an image obtained by photographing the food ingredients F.

The memory device 70 may also store a heat cooking condition prepared for each combination of types and sizes of the food ingredients F. For example, the size of the food ingredients F is any one of the thickness of the food ingredients F, the volume of the food ingredients F, the surface area of the food ingredients F, and the weight of the food ingredients F, or a combination of at least two thereof. The size of the food ingredients may be obtained by calculation based on the food ingredient image. The heat cooking condition is a condition for finishing cooking of the food ingredients F with an appropriate texture and taste in a process of heat-cooking the food ingredients F.

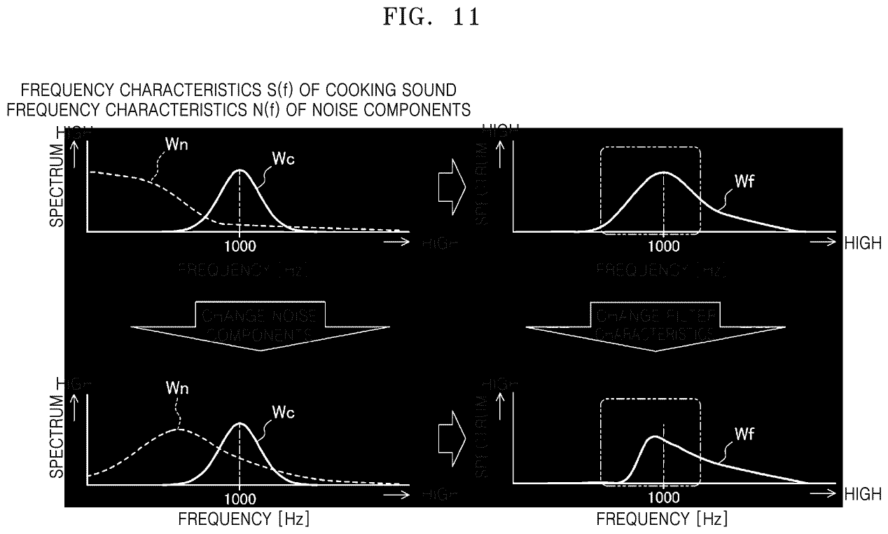

The memory device 70 may also store cooking sound data and noise data. FIG. 11 shows a graph of frequency characteristics of a cooking sound of the food ingredients F and a noise, a graph of frequency characteristics of a noise removal filter, and a relationship diagram showing an example of a relationship between the frequency characteristics. Referring to FIG. 11, cooking sound data is data representing frequency characteristics S(f) of a cooking sound. The cooking sound data exhibits a waveform Wc indicated by solid lines in the two graphs on the left of FIG. 11. The cooking sound data is set as the normally distributed waveform Wc with, for example, 1000 Hz as the average value (median value). Noise data is data representing frequency characteristics N(f) of noise components included in collected sound data detected by the sound detector 40 during heat cooking. The noise data exhibits waveforms Wn indicated by dashed lines in the two graphs on the left of FIG. 11.

The waveform Wn indicated by the dashed line in the upper left graph of FIG. 11 represents the frequency characteristics N(f) of the noise components when the number of rotations of the cooling fan 37 is relatively low. The waveform Wn indicated by the dashed line in the lower left graph of FIG. 11 represents the frequency characteristics N(f) of the noise components when the number of rotations of the cooling fan 37 is relatively high. For a plurality of stages of the number of rotations of the cooling fan 37, from the minimum number of rotations to the maximum number of rotations, noise data is prepared for each stage of the number of rotations. The frequency characteristics N(f) of a plurality of pieces of noise data are not limited to the patterns of the two waveforms Wn shown in FIG. 11, and may exist in more other waveform patterns.

For example, the number of rotations of the cooling fan 37 may be divided into three stages: a low rotation section, a medium rotation section, and a high rotation section. When the number of rotations of the cooling fan 37 is divided into thirds from the minimum number of rotations to the maximum number of rotations, the low rotation section is a range of low numbers of rotations, the medium rotation section is a range of medium numbers of rotations, and the high rotation section is a range of high numbers of rotations. As noise data, first noise data corresponding to the low rotation section, second noise data corresponding to the medium rotation section, and third noise data corresponding to the high rotation section may be prepared. Noise data may be prepared in a plurality of more specific stages.

When an operation of the heating cooker 5 is started, the internal temperature of the heating chamber 12 increases due to driving of the heating device 20. The number of rotations of the cooling fan 37 increases as the internal temperature of the heating chamber 12 increases. The driving sound of the cooling fan 37 becomes high-pitched as the number of rotations of the cooling fan 37 increases. Thus, the noise components included in the collected sound data changes depending on the number of rotations of the cooling fan 37. In detail, as the number of rotations of the cooling fan 37 increases, the noise components is shifted toward a high band, and the overlap ratio with the frequency band of a cooking sound tends to increase. According to the tendency, the frequency characteristics N(f) of each noise data is set.

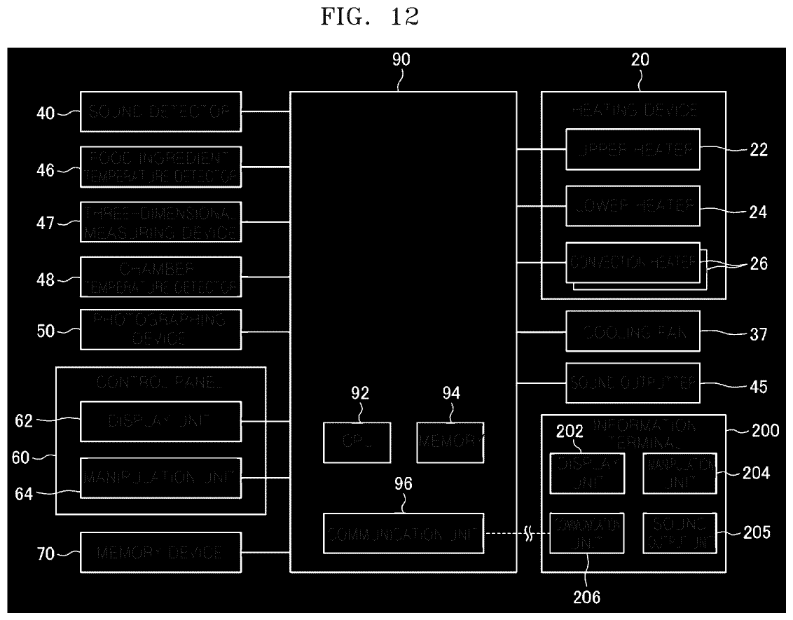

The control device 90 controls the overall operation of the heating cooker 5. FIG. 12 is a block diagram illustrating the control device 90 and its main related devices, according to an embodiment of the present disclosure. As illustrated in FIG. 12, the control device 90 is communicatively and electrically connected to the heating device 20, the cooling fan 37, the sound detector 40, the sound outputter 45, the food ingredient temperature detector 46, the three-dimensional measuring device 47, the chamber temperature detector 48, the photographing device 50, the display unit 62, the manipulation unit 64, and the memory device 70. The control device 90 may be a controller based on a known microcomputer.

The control device 90 may include a central processing unit (CPU) 92, a memory 94, and a communication unit 96. The memory 94 stores various programs and data. The CPU 92 executes a program read from the memory 94. The communication unit 96 may have a communication function using a wireless local area network (LAN), such as Wireless Fidelity (WiFi), or a communication function according to a short-range wireless communication standard, such as Bluetooth (registered trademark).

The control device 90 executes a program stored in the memory 94 to control the heating device 20 based on setting data regarding heat cooking that is input through the control panel 60, and various pieces of data input from the food ingredient temperature detector 46, the three-dimensional measuring device 47, the chamber temperature detector 48, and the photographing device 50. For example, the control device 90 may control the upper heater 22, the lower heater 24, and the convection heater 26 according to a heat cooking condition depending on the type of the food ingredients F placed in the heating chamber 12.

When heat cooking is started, the control device 90 may change the number of rotations of the cooling fan 37 according to the internal temperature of the heating chamber 12 detected by the chamber temperature detector 48. In addition, the control device 90 may increase the number of rotations of the cooling fan 37 as the internal temperature of the heating chamber 12 increases. As such, cooling of the control device 90 and the like may be accelerated. In addition, the sound detector 40 is used to detect a sound at a position outside the heating chamber 12, and sounds including the cooking sound, which comes from the food ingredients F being heated and then leaks out of the heating chamber 12 are obtained. The control device 90 removes noise components including the driving sound of the cooling fan 37, from collected sound data representing the sounds detected by the sound detector 40.

In addition, the control device 90 performs a filtering process on the collected sound data. In the filtering process, the noise components corresponding to the driving sound of the cooling fan 37 are removed by using a noise removal filter having certain frequency characteristics. As described above, as the number of rotations of the cooling fan 37 increases, the noise components tends to be shifted toward the high band. The control device 90 changes frequency characteristics H(f) of the noise removal filter according to the number of rotations of the cooling fan 37. The change in the frequency characteristics H(f) may be made across the entire frequency band of the noise removal filter.

The control device 90 of the present example changes the frequency characteristics H(f) of the noise removal filter considering a change in the frequency characteristics N(f) of the noise components included in the collected sound data. The control device 90 sets the frequency characteristics H(f) of the noise removal filter based on the frequency characteristics S(f) of the cooking sound and the frequency characteristics N(f) of the noise components. The frequency characteristics H(f) of the noise removal filter exhibits waveform Wfs shown in the two graphs on the right side of FIG. 11. The frequency characteristics H(f) of the noise removal filter may be obtained by the following equation.

$$H ( f ) = S ( f ) / \{ S ( f ) + N ( f ) \}$$

The frequency characteristics H(f) of the noise removal filter is changed to remove the noise components from the collected sound data as much as possible while leaving the components of the cooking sound, as shown in portions surrounded by two-dot chain lines in the two graphs on the right of FIG. 11. The control device 90 performs a filtering process on the collected sound data by using the noise removal filter having the above-described frequency characteristics H(f). As such, the control device 90 generates cooking sound data representing the cooking sound. The control device 90 outputs the cooking sound by using the sound outputter 45 based on the generated cooking sound data.

In addition, the control device 90 photographs the inside of the heating chamber 12 by using the photographing device 50, and obtains a captured image of the food ingredients F in the heating chamber 12. The control device 90 displays the obtained captured image by using the display unit 62. In addition, the communication unit 96 of the control device 90 may transmit, to the information terminal 200, image data representing the captured image of the food ingredients F and cooking sound data representing the cooking sound of the food ingredients F, according to a request instruction from the information terminal 200.

The information terminal 200 illustrated in FIG. 1 is a portable mobile device with a communication function. The information terminal 200 is an example of an external device. As the information terminal 200, for example, a small multifunctional mobile phone called a smart phone may be used. As illustrated in FIG. 12, the information terminal 200 may include a display unit 202, a manipulation unit 204, a sound output unit 205, and a communication unit 206. The display unit 202 and the manipulation unit 204 may be implemented by a display device with a touch panel attached thereto. The display unit 202 is a screen of the display device. The manipulation unit 204 is the touch panel. The sound output unit 205 may include a speaker.

The communication unit 206 is an interface for communicating with other devices. The communication unit 206 communicates with an external network N, which is a wide area network, such as the Internet. The communication unit 206 may have a communication function using a wireless LAN such as WiFi, or a communication function according to a mobile communication standard such as Long-Term Evolution (LTE). As particular application software is installed in the information terminal 200, communication with the heating cooker 5 through the external network N may be established.

In response to a certain input through the manipulation unit 204, the information terminal 200 transmits a request instruction for the cooking status (a captured image and cooking sound data) of the food ingredients F to the heating cooker 5. In addition, the information terminal 200 receives image data and cooking sound data transmitted from the heating cooker 5 through the communication unit 206. By a function of the application software, the captured image of the food ingredients F may be displayed on the display unit 202 of the information terminal 200 based on the received image data, and simultaneously, the cooking sound of the food ingredients F may be output from the sound output unit 205 of the information terminal 200 based on the received cooking sound data.

According to the heating cooker 5 according to an embodiment of the present disclosure, the sound detector 40 is arranged outside the heating chamber 12. Accordingly, even when the internal temperature of the heating chamber 12 rises to a high temperature during heat cooking of the food ingredients F, heat may be suppressed from reaching the sound detector 40. Thus, the sound detector 40 may operate normally without damage or malfunction due to heat effects.

The sound detector 40 is located near the blowing path through which cooling wind flows by driving of the cooling fan 37. Accordingly, even when the soot X formed in the heating chamber 12 comes out of the heating chamber 12 through the opening 11 of the main body 10 when the door 14 is opened, the soot X is removed by the cooling wind and thus may be suppressed from adhering to the sound detector. Accordingly, it is possible to suppress a deterioration of the sound quality of the cooking sound data detected by the sound detector 40.

According to the heating cooker 5 according to an embodiment of the present disclosure, the sound detector 40 is arranged near the opening 11 of the heating chamber 12. For example, the sound detector 40 is accommodated in the case portion 13 protruding in a direction in which the opening 11 of the main body 10 is oriented. Accordingly, the sound detector 40 may be arranged at a position close to the opening 11 through which a sound within the heating chamber 12 leaks out. In addition, the sound detector 40 detects a sound leaking out of the heating chamber 12 through the sound collection hole 13h formed in the case portion 13. For example, the first and second flow paths Pa and Pb may be arranged above the heating chamber 12. The first and second flow paths Pa and Pb may be partitioned in the vertical direction by the partition plate 39. The sound collection hole 13h may be provided in the partition plate 39. The sound detector 40 may be installed on the partition plate 39 within the first flow path Pa so as to be aligned with the sound collection hole 13h. Accordingly, it is advantageous to clearly obtain a cooking sound by using the sound detector 40. The sound collection hole 13h is open outside the heating chamber 12 toward the blowing path (the discharge space DS). Accordingly, the cooling wind may serve as an air curtain to suppress the soot X from adhering to the sound detector 40.

In the heating cooker 5 according to an embodiment of the present disclosure, the sound detector 40 is located near the discharge space DS. The discharge space DS is a space through which air discharged from the inside of the main body 10 to the outside flows by driving of the cooling fan 37, and is open forward from the heating chamber 12. Accordingly, with a simple configuration, the sound detector 40 arranged outside the heating chamber 12 may be located near the blowing path. According to the heating cooker 5 according to an embodiment of the present disclosure, the control device 90 removes noise components including the driving sound of the cooling fan 37, from the collected sound data collected by the sound detector 40. Accordingly, cooking sound data for clearly reproducing the cooking sound of the food ingredients F may be generated. Here, ┌to remove the noise components┐ is not limited to complete removal of the noise components, but also means removal of part of the noise components, that is, reduction of the noise components.

In the heating cooker 5 according to an embodiment of the present disclosure, the control device 90 performs a filtering process on the collected sound data. In the filtering process, a noise removal filter is used. The number of rotations of the cooling fan 37 is already known, and the frequency characteristics of the driving sound of the cooling fan 37 may also be assumed in advance. Accordingly, the noise components regarding the driving sound of the cooling fan 37 may be easily removed by reflecting the frequency characteristics of the driving sound of the cooling fan 37 in the noise removal filter.

In the heating cooker 5 according to an embodiment of the present disclosure, the control device 90 changes the frequency characteristics of the noise removal filter. The frequency characteristics of the noise removal filter are changed according to the number of rotations of the cooling fan 37. When the number of rotations of the cooling fan 37 changes, the frequency characteristics of the driving sound of the cooling fan 37 also change. By changing, according to the number of rotations of the cooling fan 37, frequency components removed from the collected sound data by using a noise removal filter, the noise components may be appropriately removed while leaving the frequency components of the cooking sound as much as possible.

The heating cooker 5 according to an embodiment of the present disclosure includes the sound outputter 45. The sound outputter 45 outputs a cooking sound based on cooking sound data. The cooking sound data is sound data obtained by removing noise components including the driving sound of the cooling fan 37 from collected sound data collected by the sound detector 40. Thus, when the food ingredients F is being heat-cooked by using the heating cooker 5, the user may hear a high-quality cooking sound and thus experience a sense of presence during cooking.

In the heating cooker 5 according to an embodiment of the present disclosure, the control device 90 includes the communication unit 96. The communication unit 96 transmits cooking sound data to the information terminal 200. When the information terminal 200 outputs a cooking sound from the sound output unit 205 based on the cooking sound data, the user may hear the cooking sound of the food ingredients F through the information terminal 200 even when the user is away from the heating cooker 5, and thus experience a sense of presence during cooking. The information terminal 200 is a portable mobile device and thus has high convenience.

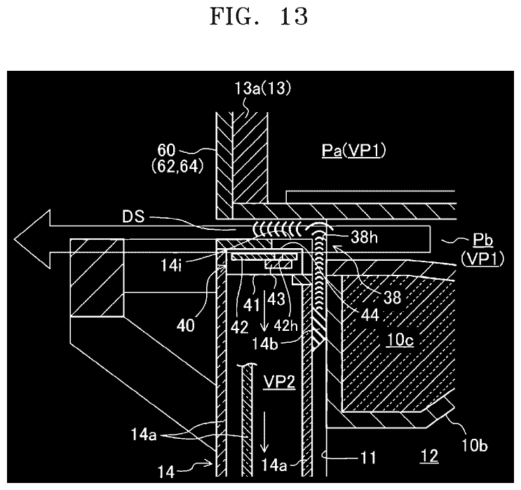

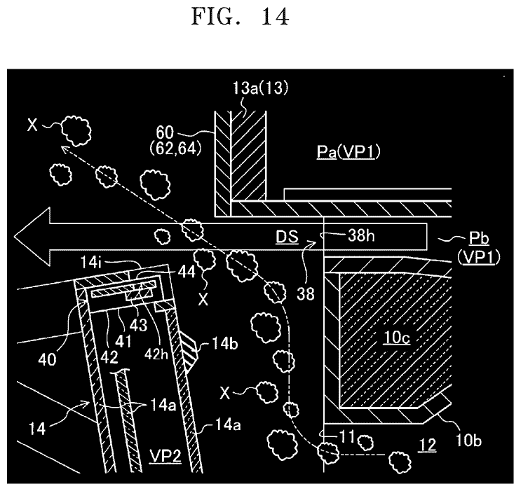

FIG. 13 is a cross-sectional view illustrating main parts of a heating cooker according to an embodiment of the present disclosure. FIG. 14 is a cross-sectional view illustrating main parts in a state in which the door 14 of the heating cooker illustrated in FIG. 13 is opened, according to an embodiment of the present disclosure. Referring to FIGS. 13 and 14, the sound detector 40 is embedded in the door 14, for example, in an upper portion of the door 14. The sound detector 40 is installed at an upper portion of the door 14 such that the sound collection portion 44, that is, the sound hole 42h for collecting sounds, faces the upper side of the inlet 14i when the door 14 is closed. When the door 14 is closed, the upper portion of the door 14 is located below the discharge path DS near the inlet 14i. Thus, the sound detector 40 is located inside the ventilation flow path VP2 near the inlet 14i and below the discharge path DS such that the sound hole 42h for collecting sounds faces the discharge path DS when the door 14 is closed. The sound detector 40 is located in the blowing path through which cooling wind flows by driving of the cooling fan 37. As illustrated in FIG. 14, when the door 14 is opened, the sound detector 40 moves away from the inside of the heating chamber 12 as the door 14 rotates. Thus, it is difficult for the soot X that comes out of the heating chamber 12 as the door 14 is opened, to adhere to the sound detector 40.

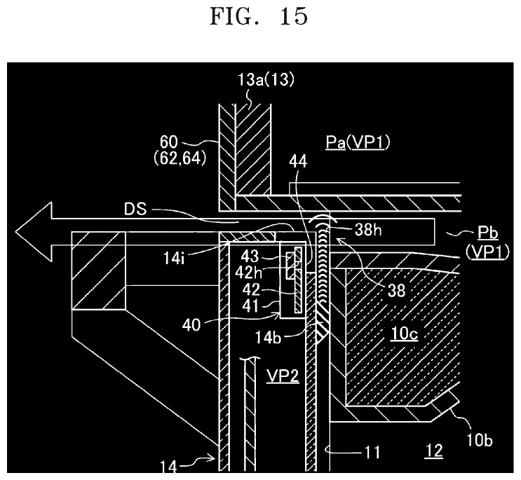

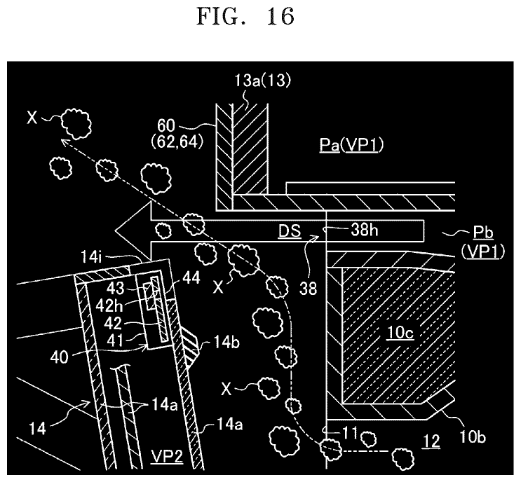

FIG. 15 is a cross-sectional view illustrating main parts of the heating cooker 5 according to an embodiment of the present disclosure. FIG. 16 is a cross-sectional view illustrating main parts in a state in which the door 14 of the heating cooker 5 illustrated in FIG. 15 is opened, according to an embodiment of the present disclosure. As illustrated in FIGS. 15 and 16, the sound detector 40 is embedded in an upper portion of the door 14. The sound detector 40 is installed in an upper portion of the door 14 such that the sound collection portion 44 faces the heating chamber 12 when the door 14 is closed. When the door 14 is closed, the upper portion of the door 14 is located below the discharge path DS near the inlet 14i. Thus, when the door 14 is closed, the sound detector 40 is located in the ventilation flow path VP2 near the inlet 14i. The sound detector 40 is arranged such that the sound hole 42h for collecting sounds faces the heating chamber 12. The sound detector 40 is located in the blowing path through which cooling wind flows by driving of the cooling fan 37. As illustrated in FIG. 16, when the door 14 is opened, the sound detector 40 moves away from the inside of the heating chamber 12 as the door 14 rotates. Thus, it is difficult for the soot X that comes out of the heating chamber 12 as the door 14 is opened, to adhere to the sound detector 40.

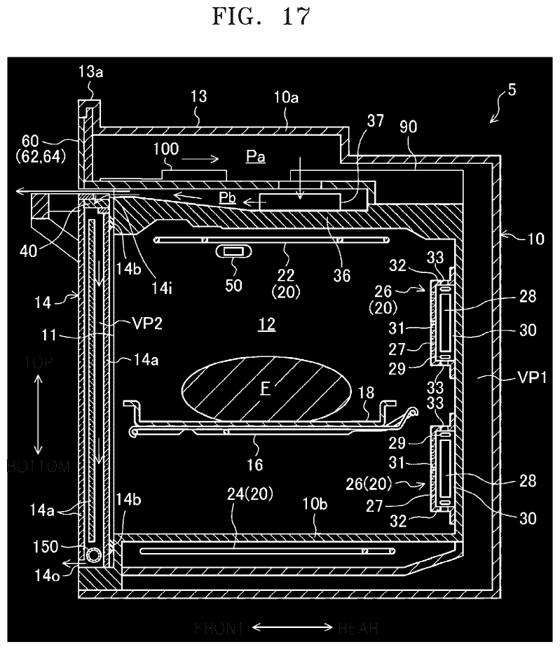

FIG. 17 is a cross-sectional view illustrating main parts of a heating cooker according to an embodiment of the present disclosure, and corresponds to a cross-sectional view taken along line V-V of FIG. 4. As illustrated in FIG. 17, the sound detector 40 is embedded in an upper portion of the door 14. The installation state of the sound detector 40 is the same as illustrated in FIG. 13 or 15. The heating cooker 5 of the present example further includes a cooling fan (second cooling fan) 150 for cooling the sound detector 40, separately from the cooling fan 37 for cooling the control device 90 and the like. The cooling fan 150 is a device configured to generate cooling wind flowing along the ventilation flow path VP2 within the door 14. The cooling fan 150 may be embedded in a lower portion of the door 14. The cooling fan 150 may be installed in the ventilation flow path VP2 near the outlet 14o. As the cooling fan 150, for example, a cross-flow blower may be employed.

When the cooling fan 150 is in operation, cooling wind is generated inside the door 4 as indicated by arrows in FIG. 17. The cooling wind is an air flow in which air of the discharge space DS is sucked into the ventilation flow path VP2 within the door 14 through the inlet 14i, then flows toward the bottom of the ventilation flow path VP2, and is then discharged from the outlet 14o. The control device 90 of the heating cooker 5 may drive the cooling fan 150 when heat-cooking the food ingredients F with the heating cooker 5. In addition, the control device 90 may stop the cooling fan 150 when the door 14 is opened. The control device 90 may stop the cooling fan 150 when heat cooking is completed or stopped. According to the structure in which the sound detector 40 and the cooling fan 150 for cooling the sound detector 40 are installed in the door 14, by driving of the cooling fan 150, cooling of the door 14 and the sound detector 40 may be accelerated. Thus, the operational reliability of the sound detector 40 may be improved.

In the heating cooker 5 according to an embodiment of the present disclosure, the control device 90 changes the number of rotations of the cooling fan 37 according to the internal temperature of the heating chamber 12 detected by the chamber temperature detector 48, and simultaneously, changes the frequency characteristics H(f) of the noise removal filter. Accordingly, the frequency characteristics H(f) of the noise removal filter is changed according to the internal temperature of the heating chamber 12 detected by the chamber temperature detector 48. By doing so, the frequency characteristics H(f) of the noise removal filter may be changed to eventually comply with the number of rotations of the cooling fan 37 even when it is not directly due to the number of rotations of the cooling fan 37.

The arrangement position of the sound detector 40 is not limited to the vicinity of the discharge space DS in the blowing path. For example, the sound detector 40 may be fixed to the lower surface of the main body 10 corresponding to the protruding portion 13a of the case portion 13, and arranged in the discharge space DS. In addition, the sound detector 40 may be arranged in a blowing path other than the discharge space DS, for example, in the first flow path Pa or the second flow path Pb.

The control device 90 does not need to change the frequency characteristics H(f) of the noise removal filter according to the number of rotations of the cooling fan 37. That is, the control device 90 may uniformly perform a filtering process on collected sound data by using a noise removal filter with particular frequency characteristics H(f).

The food ingredient temperature detector 46 may detect the internal temperature of the food ingredients F directly, for example, with contact. For example, the food ingredient temperature detector 46 may include a temperature probe. The temperature probe is to be inserted into the food ingredients F to measure the internal temperature of the food ingredients F.

The heating device 20 does not need to include all of the upper heater 22, the lower heater 24, and the convection heater 26. For example, the heating device 20 may include the upper heater 22 and the convection heater 26, and may include the upper heater 22 and the lower heater 24. The heating device 20 may include one heater.

The heating cooker 5 may receive information about the type of the food ingredients F to be cooked, through the control panel 60. In addition, the heating cooker 5 may receive information about the size of the food ingredients F to be cooked, through the control panel 60.

A food ingredient image and a heat cooking condition may be stored in a cloud server on the Internet, and the control device 90 may access the cloud server via the Internet to obtain the food ingredient image and the heat cooking condition from the cloud server.

The embodiments are described above with reference to an example in which the heating cooker 5 is an oven, but the oven is only an example of the heating cooker 5, and the technologies of the present disclosure are also applicable to other heating cookers, such as a grill attached to a stove, or a microwave oven.

A heating cooker according to an aspect of the present disclosure includes: a main body 10 including a heating chamber 12 in which food ingredients F are placed, and a blowing path through which cooling wind flows; a heating device 20 configured to heat the inside of the heating chamber; a control device 90 arranged in the blowing path and configured to control the heating device; a cooling fan 37 configured to generate the cooling wind; and a sound detector 40 arranged outside the heating chamber and near the blowing path, and configured to detect sounds including a cooking sound of food ingredients being heated in the heating chamber.

In an embodiment, the main body may include an opening 11 through which food ingredients are put in and out of the heating chamber, and the sound detector may be arranged near the opening.

In an embodiment, the blowing path may include a discharge space DS that is open forward at an upper portion of the opening of the heating chamber such that the cooling wind is discharged, and the sound detector may be arranged near the discharge space.

In an embodiment, the blowing path may include a first flow path Pa and a second flow path Pb that are located above the heating chamber and partitioned in a vertical direction by a partition plate 39, the cooling wind may be discharged from the second flow path through the discharge space, a sound collection hole 13h may be arranged in the partition plate, and the sound detector may be installed in the partition plate within the first flow path so as to be aligned with the sound collection hole.

In an embodiment, the heating cooker may further include a door 14 that opens and closes the opening of the heating chamber, the blowing path may include a discharge space DS that is open forward at an upper portion of the opening of the heating chamber such that the cooling wind is discharged, and the sound detector may be installed in the door to be adjacent to the discharge space.

In an embodiment, an inlet 14i through which the cooling wind flows from the discharge path to a ventilation flow path VP2 within the door may be arranged in the door, and the sound detector may be located in the ventilation flow path near the inlet. In an embodiment, the sound detector may be located below the discharge path such that a sound hole 42h for sound collection faces the discharge path. In an embodiment, the sound detector may be located below the discharge path such that a sound hole 42h for sound collection faces the heating chamber. In an embodiment, the heating cooker may further include a second cooling fan 150 installed in the ventilation flow path and configured to generate cooling wind flowing along the ventilation flow path.

In an embodiment, an opening 11 through which food ingredients are put in and out of the heating chamber may be formed in the main body 10, a case portion 13 including a protruding portion 13a, which protrudes in a direction in which the opening is formed, may be arranged in an upper portion of the main body, a sound collection hole 13h, which is open toward the blowing path outside the heating chamber, may be formed in the case portion, and the sound detector may be accommodated in the case portion to detect a sound through the sound collection hole.

In an embodiment, the control device 90 may be further configured to generate cooking sound data representing the cooking sound by removing noise components including a driving sound of the cooling fan from collected sound data representing a sound detected by the sound detector.

In an embodiment, the control device may be further configured to perform a filtering process on the collected sound data to remove noise components corresponding to the driving sound of the cooling fan by using a noise removal filter having certain frequency characteristics.

In an embodiment, the control device may be further configured to change the frequency characteristics of the noise removal filter according to the number of rotations of the cooling fan.

In an embodiment, the heating cooker may further include a chamber temperature detector 48 configured to detect an internal temperature of the heating chamber, and the control device may be further configured to change the number of rotations of the cooling fan according to the internal temperature of the heating chamber detected by the chamber temperature detector, and simultaneously change the frequency characteristics of the noise removal filter.

In an embodiment, the heating cooker may further include at least one of a sound outputter 45 configured to output the cooking sound based on the cooking sound data, and a communication unit 96 configured to transmit the cooking sound data to an external device.

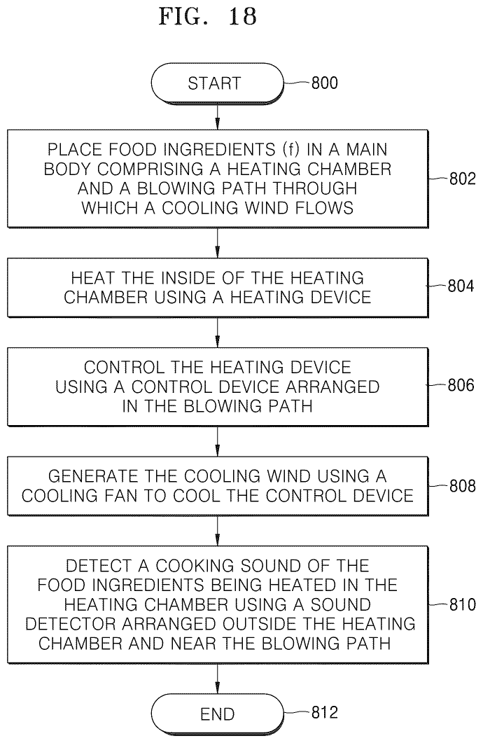

With reference to FIG. 18, a method of detecting a cooking sound is illustrated according to an embodiment of the present disclosure. The method begins at operation 800, and at operation 802 food ingredients (F) are placed in a main body comprising a heating chamber and a blowing path through which a cooling wind flows. At operation 804, the inside of the heating chamber is heated using a heating device. At operation 806, the heating device is controlled using a control device that is arranged in the blowing path. At operation 808, the cooling wind is generated using a cooling fan to cool the control device. At operation 810, a cooking sound of the food ingredients being heated in the heating chamber is detected using a sound detector arranged outside the heating chamber and near the blowing path, and the method ends at operation 812.

Preferred embodiments are described above as examples of the technology of the present disclosure. However, the technology of the present disclosure is not limited thereto, and may also be applied to embodiments with appropriate changes, substitutions, additions, or omissions. Those skilled in the art will understand that various modifications to the above embodiments are possible without departing from the spirit of the present disclosure, and that such modifications also fall within the technical scope of the present disclosure.

1. A heating cooker comprising:
a main body comprising a heating chamber in which food ingredients (F) are placed, and a blowing path through which cooling wind flows;
a heating device configured to heat inside of the heating chamber;
a control device arranged in the blowing path and configured to control the heating device;
a cooling fan configured to generate the cooling wind to cool the control device; and
a sound detector arranged outside the heating chamber and near the blowing path, and configured to detect sounds including a cooking sound of food ingredients being heated in the heating chamber.

2. The heating cooker of claim 1, wherein
the main body comprises an opening through which food ingredients are put in and out of the heating chamber, and
the sound detector is arranged near the opening.

3. The heating cooker of claim 1, wherein the blowing path comprises a discharge space (DS) that is open forward at an upper portion of an opening of the heating chamber such that the cooling wind is discharged, and
the sound detector is arranged near the discharge space.

4. The heating cooker of claim 3, wherein the blowing path comprises a first flow path (Pa) and a second flow path (Pb) that are located above the heating chamber and partitioned in a vertical direction by a partition plate,
the cooling wind is discharged from the second flow path through the discharge space,
a sound collection hole is arranged in the partition plate, and
the sound detector is installed in the partition plate within the first flow path so as to be aligned with the sound collection hole.

5. The heating cooker of claim 1, further comprising a door that opens and closes an opening of the heating chamber,
the blowing path comprises a discharge space (DS) that is open forward at an upper portion of the opening of the heating chamber such that the cooling wind is discharged, and
the sound detector is installed in the door to be adjacent to the discharge space.

6. The heating cooker of claim 5, wherein an inlet through which the cooling wind flows from a discharge path to a ventilation flow path (VP2) within the door is arranged in the door, and
the sound detector is located in the ventilation flow path near the inlet.

7. The heating cooker of claim 6, wherein the sound detector is located below the discharge path such that a sound hole for sound collection faces the discharge path.

8. The heating cooker of claim 6, wherein the sound detector is located below the discharge path such that a sound hole for sound collection faces the heating chamber.

9. The heating cooker of claim 6, further comprising a second cooling fan installed in the ventilation flow path and configured to generate cooling wind flowing along the ventilation flow path.

10. The heating cooker of claim 1, wherein an opening through which food ingredients are put in and out of the heating chamber is formed in the main body,
a case portion comprising a protruding portion, which protrudes in a direction in which the opening is formed, is arranged in an upper portion of the main body,
a sound collection hole, which is open toward the blowing path outside the heating chamber, is formed in the case portion, and
the sound detector is accommodated in the case portion to detect a sound through the sound collection hole.

11. The heating cooker of claim 1, wherein the control device 90 is further configured to generate cooking sound data representing the cooking sound by removing noise components comprising a driving sound of the cooling fan from collected sound data representing a sound detected by the sound detector.

12. The heating cooker of claim 11, wherein the control device is further configured to perform a filtering process on the collected sound data to remove noise components corresponding to the driving sound of the cooling fan by using a noise removal filter having certain frequency characteristics.

13. The heating cooker of claim 12, wherein the control device is further configured to change the frequency characteristics of the noise removal filter according to a number of rotations of the cooling fan.

14. The heating cooker of claim 12, further comprising a chamber temperature detector configured to detect an internal temperature of the heating chamber,
wherein the control device is further configured to change the number of rotations of the cooling fan according to the internal temperature of the heating chamber detected by the chamber temperature detector, and simultaneously change the frequency characteristics of the noise removal filter.

15. The heating cooker of claim 11, further comprising at least one of a sound outputter configured to output the cooking sound based on the cooking sound data, and a communication unit configured to transmit the cooking sound data to an external device.

16. A method of detecting a cooking sound, the method comprising:
placing food ingredients (F) in a main body comprising a heating chamber and a blowing path through which a cooling wind flows;
heating the inside of the heating chamber using a heating device;
controlling the heating device using a control device arranged in the blowing path;
generating the cooling wind using a cooling fan to cool the control device; and
detecting a cooking sound of the food ingredients being heated in the heating chamber using a sound detector arranged outside the heating chamber and near the blowing path.

17. The method of claim 16, further comprising:
arranging the sound detector near an opening of the main body through which food ingredients are put in and out of the heating chamber, and
putting the food ingredients in the opening.

18. The method of claim 16, further comprising:
arranging the sound detector near a discharge space that is open forward at an upper portion of an opening of the heating chamber; and
discharging the cooling wind from the discharge space (DS) and adjacent the sound detector.

19. The method of claim 18, further comprising:
establishing a first flow path (Pa) and a second flow path (Pb) above the heating chamber;
partitioning the first flow path (Pa) and the second flow path (Pb) in a vertical direction using a partition plate;
arranging a sound collection hole in the partition plate;
installing the sound detector in the partition plate and within the first flow path such that the sound detector is be aligned with the sound collection hole; and
discharging the cooling wind from the second flow path via the discharge space.

20. The method of 16, further comprising:
installing the sound detector in a door installed adjacent to a discharge space (DS), the door configured to open and close an opening of the heating chamber; and
discharging the cooling winding along the blowing path and from the discharge space (DS) and past the sound detector in the door.
